(19) United States
(12) Patent Application Publication
(10) Pub. No.: US 2021/0020061 A1
(43) Pub. Date: Jan. 21, 2021

(54) [METHOD AND APPARATUS FOR BREATHING CAPACITY SIMULATION

(71) Applicant: Marc Chase Weinstein, Glen Cove, NY (US)

(72) Inventor: Marc Chase Weinstein, Glen Cove, NY (US)

(21) Appl. No.: 16/933,902

(22) Filed: Jul. 20, 2020

Related U.S. Application Data
(60) Provisional application No. 62/875,554, filed on Jul. 18, 2019.

(51) Int. Cl. G09B 9/00; G09B 19/00

(52) U.S. Cl. CPC G09B 9/00; G09B 19/00

(57) ABSTRACT

A method, an apparatus and a kit comprising the apparatus for simulating a progression of a breathing disease, using a breathing capacity simulation device is provided. The method includes adjusting, a constraint structure configured to constrain, variably, a flow of air therethrough, to a desired constraint level representing a level of progression of the breathing disease, and then, breathing, via a mouthpiece having a shape and size suitable for sealable suction of air through the mouth of a user. The breathing capacity simulation device includes the mouthpiece, the constraint structure, and a body, sealably coupling the mouthpiece and the constraint structure, wherein breathing air via the mouthpiece causes air intake or out-take only via the constraint structure.

### CROSS-REFERENCE TO RELATED APPLICATIONS

This application claims the benefit of U.S. Provisional Application No. 62/875,554, filed on Jul. 18, 2019, the contents of which are incorporated herein by reference in its entirety.

### BACKGROUND

### Field

The present invention relates generally to a method and an apparatus for breathing capacity simulation, and more particularly, to simulating, for a user, progression of a breathing disease in the user.

### Description of Related Art

Chronic obstructive pulmonary disease (COPD) generally describes a group of respiratory tract diseases that are characterized by airflow obstruction or limitation. Diseases associated with COPD include bronchitis, emphysema, asthma, lung cancer, among others. COPD is the fourth leading cause of death and the second leading cause of major disability among the major diseases. More than 30 billion dollars are expended per year in medical costs, hospitalization, physician office visits, and other indirect costs (e.g., loss of work days and premature mortality), and these costs continue to escalate as the prevalence of COPD continues to rise.

In COPD, breathing problems worsen gradually over time, and can limit normal activities of a person, although treatment and precaution, such as changes in lifestyle including avoiding smoking, vaping, exposure to other irritants and the like, can help delay or prevent the worsening of the conditions. Since the breathing problems worsen over time, incremental difficulty in breathing does not instigate the urgency of timely and sufficient treatment or precaution in a patient. In fact, the patient because the patient does not readily experience difficulty in breathing, the patient may not appreciate the gravity of the issue, and in many cases, may become careless or ignorant of the need for treatment and precaution, leading to accelerated worsening of the disease.

As a preventive measure, it is important to educate a patient regarding the disease and the conditions of their lungs to provide the patient incentive to change their lifestyle and be proactive about treatment and maintaining precautions. Currently available devices to monitor the conditions of the lungs are either expensive, complex to use, or both. In many cases, use of conventional techniques may require help of a professional and/or a visit to a medical facility, which is a deterrent for many patients trying to take control of the treatment of their disease and maintaining appropriate precautions. Moreover, the conventional devices relate to identifying the current stage of a disease, and medical professionals may describe symptoms of disease progression, which the patient may or may not fully appreciate, and certainly cannot experience.

Accordingly, there exists a need for a simple and inexpensive tool to help a patient experience how their disease would progress.

### SUMMARY

A method and an apparatus for breathing capacity simulation, substantially as shown in and/or described in connection with at least one of the figures, as set forth more completely in the claims, are disclosed. Various advantages, aspects, and novel features of the present disclosure, as well as details of an exemplary embodiment thereof, will be more fully understood from the following description and drawings.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings and disclosure depict exemplary embodiments of the invention and are therefore not to be considered limiting of the scope of the particular forms described, for those skilled in the art will recognize additional embodiments of the present invention, which covers all modifications, equivalents, and alternatives within the spirit and scope of the present invention as defined by the appended claims.

FIG. 1A and FIG. 1B illustrate a breathing capacity simulation device having a user adjustable constraint structure, according to embodiments of the invention.

FIG. 2 illustrates a flute-style breathing capacity simulation device with multiple openings, according to embodiments of the invention.

FIG. 3 illustrates the breathing capacity simulation device with multiple breathing tubes, according to embodiments of the invention.

FIG. 4 illustrates a method for simulating a progression of a breathing disease using a breathing capacity simulation device, according to embodiments of the invention.

FIG. 5A and FIG. 5B depict a kit box having a breathing capacity simulation device, according to embodiments of the invention.

### DETAILED DESCRIPTION

A method and an apparatus for breathing capacity simulation device is provided. The breathing capacity simulation apparatus includes a device comprising a mouthpiece having a shape and size suitable for sealable flow of forced air using the mouth (lips) of a user. Such forced air flow in a direction to the user is referred to as suction, inspiring, inhalation, or oral inhalation and such forced flow in a direction out of the user is referred to as blowing, expiring, exhalation, or oral exhalation. A constraint structure is configured to constrain, variably, a flow of air through the mouthpiece. A body sealably couples the mouthpiece and the constraint structure, such that the flow of air via the mouthpiece causes air intake and out-take only via the constraint structure.

The breathing capacity simulation device is a hand-held device, with an opening of the mouthpiece placed on the lips for inhalation and exhalation, hereinafter called “breathing.” The patient or the user configures the constraint structure to simulate a desired level of breathing disease progression, and inhales and exhales through the mouthpiece. Such inhalation and exhalation causes the user to experience difficulty or impairment in breathing representative of the progression of the breathing disease. The user may also determine, based on the constraint level at which a user is able to sustain breathing for a predetermined length of time, the current level of disease progression. Accordingly, the breathing capacity simulation device is particularly well suited as an experiential educational tool that allows the user to experience the worsening effects of breathing diseases. The predetermined length of time is selected according to the level of fitness with respect to breathing for users at known constraint levels, and is well known in the art.

The disclosed method and apparatus for breathing capacity simulation, and various embodiments thereof, overcome the disadvantages of the conventional solutions, and provides a simple apparatus to a patient (or a user), and a simple method to use the apparatus, for the patient/user to experience the progression of their disease. Specifically, according to various embodiments described herein, the apparatus and method enable experiential self-assessment of COPD progression, providing a powerful motivation for timely and appropriate treatment, and suitable precautions. Additionally, the embodiments described herein enable the user to assess the current stage of their disease.

In accordance with an embodiment, a breathing capacity simulation device comprises a mouthpiece having a shape and size suitable for making a sealable connection for the flow of air through the mouth (lips) of a user, a constraint structure configured to constrain, variably, a flow of air therethrough, and a body, sealably coupling the mouthpiece and the constraint structure. The flow of air via the mouthpiece causes air intake and out-take only via the constraint structure. In some example embodiments, a compound device comprises a strip and at least two devices structurally joined by the strip.

In accordance with an embodiment, a method for simulating a progression of a breathing disease, using a breathing capacity simulation device is provided. The method comprises adjusting, a constraint structure that is configured to constrain, variably, a flow of air therethrough, to a desired constraint level representing a level of progression of the breathing disease, and then breathing, that is, inhaling (inspiring) or exhaling (expiring) through the mouthpiece to experience breathing according to a given level of progression of the breathing disease. As noted, the method includes exhaling (expiring) thorough the same mouthpiece, such that the entire breathing is continuously performed via the mouthpiece. In some embodiments, the method includes only inhaling or only exhaling through the device, depending on the specific patient-type and disease and state. It is expected that the lack of oxygen to the user's lungs, due to the reduced air flow caused by the constraint structure, and/or the lack of expiring the breathed in air (including carbon dioxide) from the lungs simulates an advanced stage of disease. Such a simulation would be effective in persuading a user to seek effective treatment and adopt precautionary measures proactively.

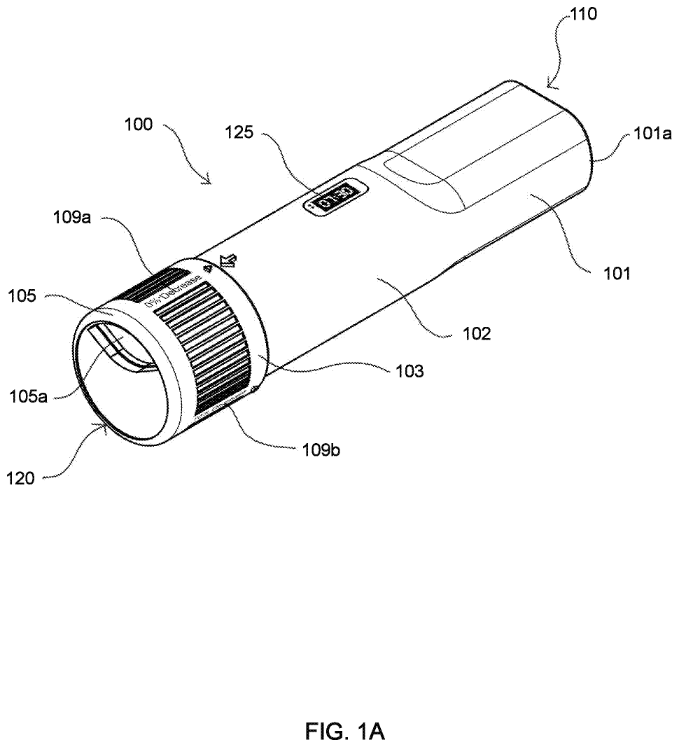

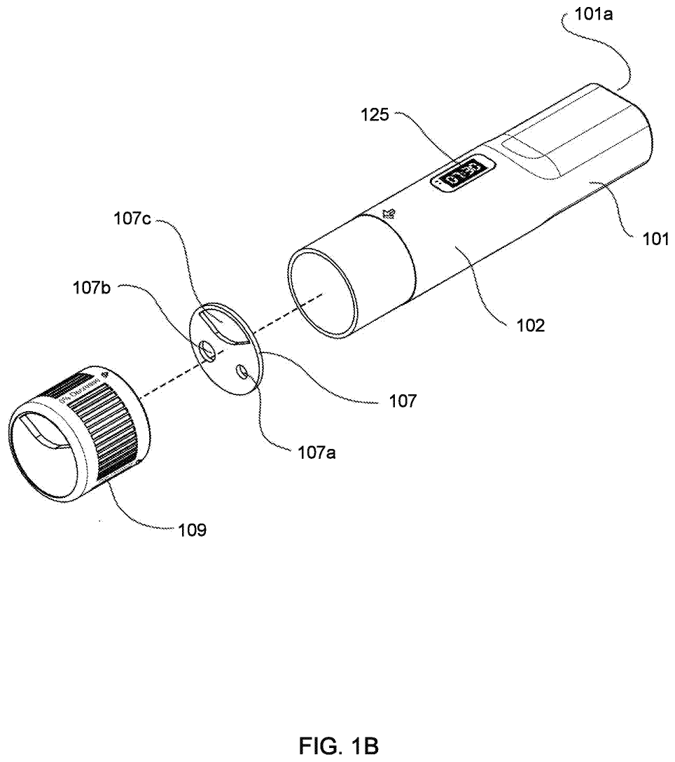

FIG. 1A and FIG. 1B illustrate an apparatus 100 for breathing capacity simulation comprising a breathing capacity simulation device 100, according to embodiments of the invention. The device 100 comprises a mouthpiece 101, a body 102, and a constraint structure 103. The constraint structure 103 is configurable to constrain flow of air therethrough, which in turns configures the amount of flow of air through the mouthpiece 101.

The mouthpiece 101 has a shape and size suitable for sealable flow of air through the mouth of a user, for example, via an opening 101a. In accordance with an embodiment, the shape of the opening 101a may be a rounded edge rectangle for ease of lip placement of the user, and sealing therewith. In some embodiments, for example, the embodiments of FIGS. 1A and B, include a one-way valve to allow exhaled air to escape the device 100, while maintaining seal while inhaling through the device 100. The one-way valve comprises a hole in the mouthpiece covered by a flap thereon in a sealable manner, where the flap is larger than the hole and is movable in outward direction away from the hole, and not movable inward into the hole. When the user inhales air, the flap is pulled in towards the hole, and the flap maintains the seal with the hole. When the user exhales air, if the air is constrained in being released via the constraint structure, the exhaled air pushes on the flap, which moves outward and away from the hole, releasing the exhaled air. When the user inhales next, the flap is pulled, once again, towards the hole to form a seal.

In some embodiments, the body 102 has a tubular shape. The body 102 comprises a first end 110 and a second end 120, the second end 120 opposite to the first end 110. In the embodiment illustrated by FIGS. 1A and 1B, the mouthpiece 101 is located at the first end 110, and the constraint structure 103 is located close or proximal to the second end 120, which is an open end. The body 102 couples the mouthpiece 101 and the constraint structure 103 in a sealed manner, that is, the constraint structure 103 and the mouthpiece 101 are in a sealed communication. All flow of air via the mouthpiece 101 results in air intake and out-take only through the constraint structure 103. In some embodiments, the constraint structure 103 is a part of the body 102, while in some embodiments, the constraint structure 103 is sealably associated with the body 102.

The constraint structure 103 comprises an end cap 105 and a disc 107. The disc 107 has a shape matching the cross section of the body 102. The disc 107 is positioned in the body 102 or at the second end 120 to form a sealed configuration around the edges of the disc 107 and the body 102, to form a barrier to flow of air through the disc 107. The disc 107 comprises one or more disc openings 107 a-c to allow passage of air through the disc 107. Any air may flow in the tube 102 only through the openings 107a-c of the disc.

The end cap 105 is positioned on the second end 120 of the body 102, farther to the first end 110 as compared to the disc 107, and the end cap 105 is positioned over the disc 107. The end cap 105 is rotatable on the second end 120, with respect to the body 102 and the disc 107. In some embodiments, the end cap 105 is configured to be in contact with and slide rotatably in relation to the disc 107 when assembled, so as to form a relative seal between the end cap 105 and the disc 107, except for openings in either of the end cap 105 and the disc 107. In some embodiments, the disc 107 is integrally formed with the body 102, while in other embodiments, the disc 107 is formed as a separate component. In some embodiments, the end cap 105 comprises an end cap opening 105a that is larger than the disc openings 107a-c. The end cap opening 105a is located in the end cap 105, and the disc openings 107a-c are located in the disc such that the end cap opening 105a may be aligned with one or more disc openings 107a-c by rotating the end cap 105 with respect to the disc 107. Aligning the end cap opening 105a with the one or more disc openings 107a-c allows the flow of air through the end cap opening 105a and the one or more disc openings 107a-c, into the body 102.

In some embodiments, the end cap opening 105a has a size of approximately one-third the area of the end cap 105a. In some embodiments, the disc openings 107 a-c are positioned on the disc 107 spaced apart such that, at a given time, it is possible to align the end cap opening 105a with only one of the disc openings 107a-c, such that the end cap opening 105a may align with and expose only one disc opening from the disc openings 107a-c. In some embodiments, each of the disc openings 107a-c is completely eclipsed by a portion of the end cap 105 other than the end cap opening 105a, permitting no air flow through the constraint structure 103.

In an embodiment, the end cap 105 is rotated to align the end cap opening 105a with a desired disc opening 107a or 107b or 107c, each of which may have a different size, corresponding to allowing a different volume of air therethrough, representative of capacity of a user's/patient's body (e.g. lungs) to breathe. Such rotation of the end cap 105 configures the device 100 to allow a user of the device (e.g. a patient of a breathing disease) to inhale of exhale, or both, an amount of air that may pass though one of the disc openings 107a-c. For example, if the disc opening 107c is aligned with the end cap opening 105a, then flow of air is allowed according to the disc opening 107c. No air flows from the other disc openings 107a or b, because the end cap opening 105a only exposes the disc opening 107c when properly aligned with the disc opening 107c, and the disc 107 blocks any air passage through openings 107a or b.

In some embodiments, the end cap opening 105a and the disc openings 107a-c may be shaped and sized to provide different variations of air flow therethrough. As such, the rotation of the end cap 105 with respect to the disc 107 aligns the end cap opening 105a with one or more of the disc openings 107a-c to allow air intake according to the dimension of a joint passage formed by the alignment of the end cap opening 105a and the one or more disc openings 107a-c. Such alignment may be used to configure the air intake to the device 100, which air intake simulates stages of the progression of the breathing disease. For example, a large passage for air flow defined by the openings 105a with 107a-c simulates an early stage of the breathing disease, while a small or no passage for air intake corresponds to an advanced stage of the breathing disease. When the user breathes through the mouthpiece 101, the user is able to experience (simulate) his or her breathing capacity according to the configured stage of breathing disease.

In some embodiments, the end cap 105 may comprise markings 109a and 109b to indicate the rotation of the end cap 105, to help a user readily ascertain the level of constraint placed on air passage. Thus, the device 100 is easily configurable by rotating the end cap 105 to cover one or more disc openings 107a-c, for example, according to the markings 109a-b, to simulate a desired level of progression of the breathing disease. In some embodiments, less or more disc openings than those shown in the FIGS. 1A and B may be incorporated into the device 100.

In some embodiments, based on the constraint level at which a user is able to sustain breathing (including inhaling, exhaling, or both) for a predetermined length of time, the user may determine a level of the disease progression. In some embodiments, the device 100 comprises a clock 125 installed on the body 102, for the user to readily ascertain the length of time for which the user is able to sustain breathing. In some embodiments, the clock 125 includes a stopwatch or an alarm, including visual or audio notifications to indicate to the user about the passage of time.

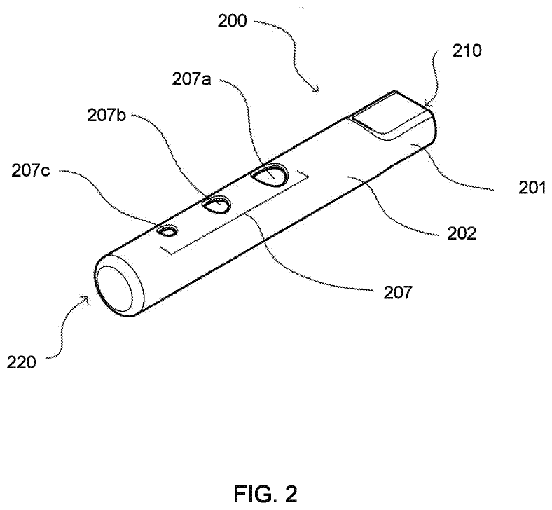

FIG. 2 illustrates a breathing capacity simulation device 200, according to embodiments of the invention. The device 200 includes a mouthpiece 201 at a first end 210 of the device 200, a body 202 and the constraint structure 207. The mouthpiece 201 and the body 202 are functionally similar to the mouthpiece 101 and the body 102 of FIGS. 1A and B, respectively, except that in the device 200, the constraint structure 207 comprises multiple finger holes 207a, 207b and 207c shaped on the body 202, and a second end 220 of the device 200 is completely closed. The finger holes 207a, 207b, 207c are sized to be completely covered by a finger of the user. The finger holes 207a, 207b, 207c may allow intake and out-take of air therethrough, and the tubular body 202 allows communication of the airflow to the mouthpiece 201. Aside from the finger holes 207a, 207b, 207c, the device 200 has no other opening to allow airflow to be communicated to the mouthpiece 201. In some embodiments, each of the finger holes 207a, 207b, 207c has a size dissimilar to the other.

By placing one or more fingers on one or more of the finger holes 207a, 207b, 207c, a user can configure the device 200 to allow an amount of airflow according to a progression state of the state of the disease. For example, the user may close one or two or all of the finger holes 207a-c, where closure of more openings and/or larger openings allows less air to pass through the device 200, simulating an advanced stage of the breathing disease, while closure of less openings and/or smaller openings simulates an early stage of the breathing disease. and while breathing through the mouthpiece may experience different stages of progression of the breathing disease. Thus, the device 200 is easily configurable by covering one or more finger holes 207a-c by a user's fingers, to simulate a desired level of progression of the breathing disease. In some embodiments, less or more holes than those shown in the FIG. 2 may be incorporated into the device 200.

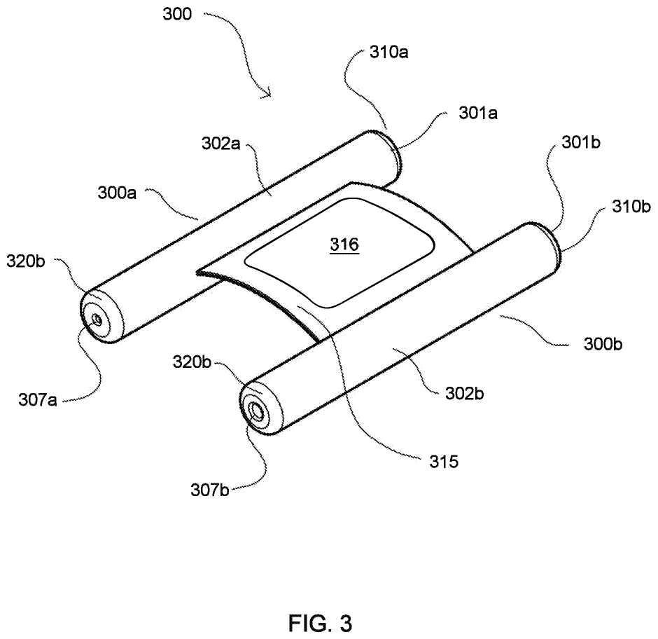

FIG. 3 illustrates a compound device 300, according to embodiments of the invention. The compound device 300 comprises at least two devices, a first device 300a and a second device 300b, structurally joined by a strip 315. In some embodiments, the first device 300a and the second device 300b include a device 100 according to FIGS. 1A and B, a device 200 according to FIG. 2, or one of each of the device 100 and the device 200.

In some embodiments, the first device 300a and the second device 300b is configured as shown in FIG. 3. The first device 300a comprises a first tubular hole 307a in a body 302a that extends from a mouthpiece 301a at a first end 310a of the device 300a to a second end 320a of the body 302a of the first device 300a. The second device 300b comprises a second tubular hole 307b in a body 302b that extends from a mouthpiece 301b at a first end 310b of the device 300b to a second end 320b of the body 302b of the first device 300b. The sizes of the first tubular hole 307a and the second tubular hole 307b are dissimilar, and allow a different amount of airflow through the respective devices 300a and 300b, representing a different stage of progression of the disease.

In some embodiments, the strip 315 includes a display region 316 to display information, such as, for example, of a provider of treatment for breathing diseases, related medicines, an instruction manual for use of the device 300, a reference manual for assessing the progression of the disease, among other similar information. In some embodiments, such information may be displayed on the body 102, 202 or 302a/302b.

In some embodiments, the apparatus includes devices made for one-time disposable simulators, for example, using light plastics and/or rubber, and in some embodiments, the apparatus is designed with long lasting materials such as high grade plastic, rubber, metal, glass or composite materials, to make the apparatus suitable for long term use.

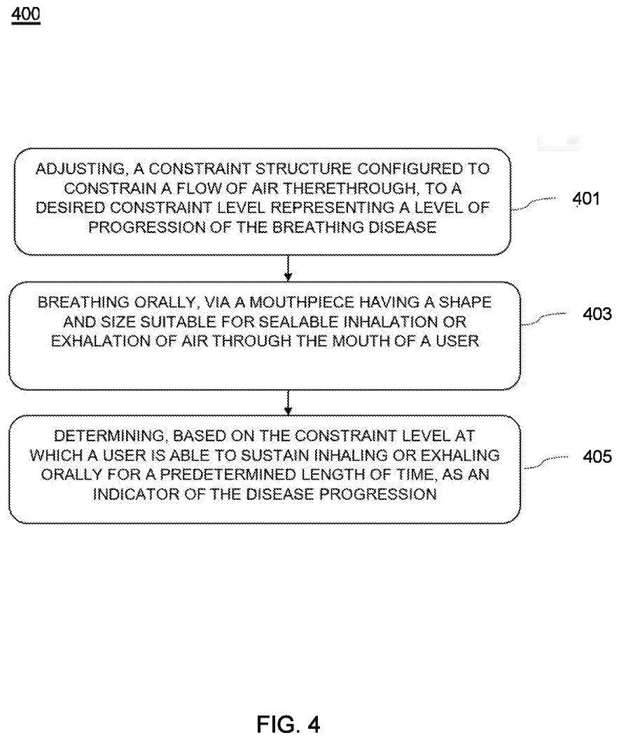

FIG. 4 illustrates a method 400 for simulating a progression of a breathing disease, for example, using a breathing capacity simulation device 100, 200 or 300, according to embodiments of the invention.

The method 400 begins and proceeds to step 401, at which, the method 400 configures a constraint structure to constrain or adjust a flow of air therethrough, to a desired constraint level representing a level of progression of the breathing disease.

For example, as discussed with reference to FIGS. 1A and B, the user configures or adjusts the constraint structure 107 of the device 100 for use by rotating the end cap 105 to align with one of the multiple openings 107a, 107b, 107c of the disc 107, to expose a disc opening via the end cap opening 105a. For example, if the disc opening 107b is aligned with the cap opening 105a, then the amount of flow of air is constrained by the size of the disc opening 107b. No air flows from the other disc openings 107a, or 107c, because the cap opening 105a only exposes the disc opening 107b when properly aligned therewith.

As another example, as discussed with reference to FIG. 2, the user configures or adjusts the constraint structure 207 of the device 200 for use by covering one or more finger holes 207a-c by a user's fingers. For example, the user may configure the constraint structure cover two holes 207b and c, leave the hole 207a exposed. In this example, upon inspiration, the air intake will occur only via the hole 207a into the body 202, which air intake will be communicated to the mouthpiece 201.

As yet another example, as discussed with reference to FIG. 3, the user configures or adjusts the constraint structure of the device 300 for use by selecting one of the devices 300a or 300b, to inspires via the corresponding mouthpiece 301a or 301b, respectively.

The method 400 proceeds to step 403, at which the method 400 includes inspiring, that is, inhaling orally, via a mouthpiece having a shape and size suitable for sealable suction of air through the mouth of a user. For example, the mouthpieces 101, 201 and 301 of devices 100, 200 and 300, respectively, are shaped for sealable suction via a user's lips.

The method 400 proceeds to step 405, at which the method 400 determines, based on the constraint level at which a user is able to sustain inhaling orally for a predetermined length of time, the progression of the disease. In some embodiments, the predetermined length of time corresponds to time needed for one or more deep breaths. In some example embodiments, the breathing capacity simulation apparatus may also include a timer to enable the user to monitor their specific breathing segments durations. Upon completion of step 405, the method 400 ends.

In some embodiments, the breathing capacity simulation apparatus comprises an integrally built mouthpiece. In some embodiments, the apparatus comprises the body designed to accommodate replaceable mouthpieces, for example, for use by multiple users. In some embodiments, the apparatus includes sensors (pressure, flow volume, time) and communication implements (Bluetooth, Near-Field-Communication (NFC), among others) to incorporate communication capability with devices such as smartphones, tablets, computers and the like, to enable display, recording and other analytics with respect to the simulation of the progression of the user's breathing disease.

For example, the breathing capacity simulation apparatus may be integrated into a patient education program with the goal of behaviour modification such as discouraging the habit of smoking or vaping. The patient education program can be created with minimal information and protocol, and may include a printed page/booklet, or other information material which defines COPD, how it affects the lungs, include specific step by step instruction for using breathing capacity simulation apparatus, and how the disease affects an individual's overall health. Further, patient education program may also include an app that may create interaction between the patient or user, the user's doctor or any other party selected by the user. In some embodiments, the apparatus may include electronic components for delivering the information wirelessly to the medical provider or chosen party or the user's own “behaviour modification program online account.” The information may be shared with the patient/user, a healthcare provider, a pharmaceutical company, or other research organizations, for example, to analyze the information and patterns towards combating breathing diseases. In some embodiments, the electronic components include an automated voice prompt generator to prompt the user while the user is using the apparatus, for example, in conjunction with the selected constraint level, and the duration for which the user is able to sustain breathing at the selected constraint level. For example, as a user stops breathing through the smallest disc opening in the device 100 of FIGS. 1A and 1B, in a duration less than a predetermined duration of time, the voice prompt may announce that “you will not be able to climb steps, brisk walking will tire you very quickly.” In some embodiments, the electronic components may communicate other information gleaned from sensors within breathing capacity simulation apparatus to communicate with the medical professional, to carry out the elements of the patient education.

The patient education program may be initiated in schools, colleges to educate students with regards to the effect of smoking, be presented in large assembly presentations with audio/video, speakers (patients, athletes, and others) interactive large group exercises, which helps in creating peer support, and the like.

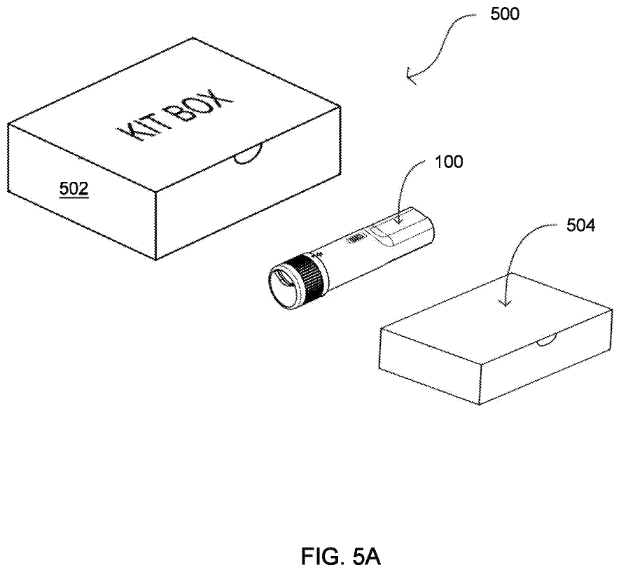

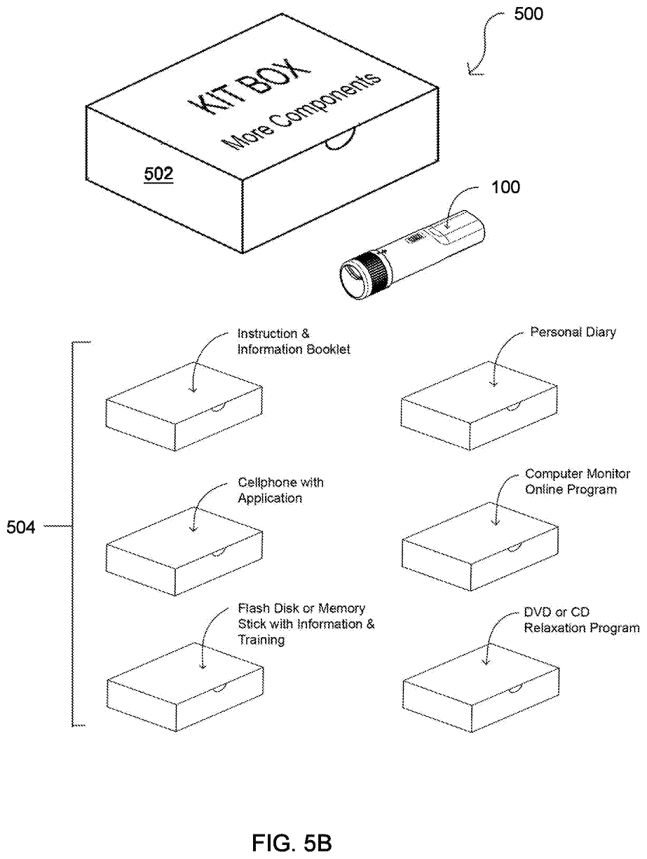

FIG. 5A and FIG. 5B depict a kit 500 having a breathing capacity simulation device, according to embodiments of the invention. While FIGS. 5A and 5B depict the device 100 of FIGS. 1A and 1B, the kit 500 may include the device 200 (FIG. 2) or 300 (FIG. 3). The kit 500 is a packaging configuration for distribution to target audience, for example, young adults, people at risk of smoking, vaping, being exposed to harmful air contaminants, people suffering from breathing disease, among others. The kit 500 includes one of the devices according to the embodiments, described herein, for example, one of the devices 100, 200 or 300, placed in a box 502, along with an instructional and/or informational booklet 504. The booklet may contain information about breathing diseases, causes, preventions, and/or instructions about using the device to simulate the progression of the breathing disease properly. In some embodiments (e.g. FIG. 5B), the information and/or instructions may be supplied via the booklet or media other than the booklet, including, without limitation, a personal diary, a smartphone application or a representative link to download such an application, a computer monitor online program, a website, a portable data memory stick, or a DVD/CD, where such information includes a stress reduction and/or guided imagery program that is designed to relax the person as well as provide and support superior behaviour modification through the guided imagery or other methods. The combination of detailed information and instructions with experience of difficulty in breathing simulated via the devices described herein is considered to be very informative and persuasive for a user, such as people at risk of developing or people having a breathing disease.

The embodiments described herein provide an inexpensive, easy to manufacture and simple to use patient education and behaviour modification tool. The apparatus is expected to have a powerful impact on about 65,000,000 people affected by COPD worldwide, and several millions of others, whose condition is not as severe, but approaching a COPD diagnosis. The experiential aspect of the apparatus will function as a “behaviour influencer” for those simply trying to quit smoking and those who are considering becoming a smoker.

The apparatus described according to embodiments herein would also be valuable for family and friends to better empathize with a person having a breathing disease, e.g., COPD, and associated experience of such a person, which would increase understanding and support for the person to follow the behaviour modification practices to help treat, manage or cope with the breathing disease. The devices and kits described according to the embodiments disclosed herein may be distributed to patients of breathing diseases or smokers, for display and use in doctor's offices, next to smoking cessation locations, smokers' healthcare providers, as part of a telemedicine visit, and the like. The devices according to the embodiments described herein may also be sent, fore example, via mail, to candidate users as a small kit as discussed above.

Although only a few exemplary embodiments of the present invention have been described in detail above, those skilled in the art will readily appreciate that many modifications are possible in the exemplary embodiments without materially departing from the novel teachings and advantages of this invention. For example, various disc openings and end cap opening configurations can be incorporated of in the device 100, various configurations of finger holes can be incorporated in the device 200, and additional number of devices can be used in the compound device 300, the mouthpiece or the body may comprise a telescoping construction, or include a variable aperture which can widen or narrow the cross section of the body or the mouthpiece, to create different volumes of air intake in the apparatus, and all such and other obvious variations are contemplated herein.

The foregoing description of embodiments of the invention comprises a number of elements, devices, machines, components and/or assemblies that perform various functions as described. These elements, devices, machines, components and/or assemblies are exemplary implementations of means for performing their respectively described functions. While the foregoing is directed to embodiments of the present invention, other and further embodiments of the invention may be devised without departing from the basic scope thereof.

1. A breathing capacity simulation device comprising:
a mouthpiece having a shape and size suitable for sealable flow of air through the mouth of a user;
a constraint structure configured to constrain, variably, a flow of air therethrough; and
a body, sealably coupling the mouthpiece and the constraint structure,
wherein breathing of air via the mouthpiece causes air intake or out-take only via the constraint structure.

2. The device of claim 1, wherein the body is a tubular body comprising a first end, and a second end opposite the first end,
wherein the first end is the mouthpiece,
wherein the constraint structure is proximal to the second end, the constraint structure comprising:
a disc positioned on the second end, in the tubular body in a sealed configuration, forming a barrier to flow of air therethrough, the disc comprising at least one disc opening to allow passage of air therethrough,
an end cap positioned on the second end, the end cap located farther to the first end as compared to the disc, the end cap configured to be in contact with and slide rotatably in relation to the disc when assembled, the end cap comprising an end cap opening larger than the at least one disc opening,
wherein when the at least one disc opening is not eclipsed by the end cap opening, air intake according to the dimension of the at least one disc opening is possible through the constraint structure, and the tubular body enables communication of the intake air to the mouthpiece, and
wherein when the at least one disc opening is completely eclipsed by a portion of the end cap other than the end cap opening, no air intake is possible through the constraint structure.

3. The device of claim 2, wherein the at least one disc opening comprises a first opening and a second disc opening, the sizes of the first opening and the second opening being dissimilar,
wherein the end cap opening is shaped to cover the largest of the at least one disc opening, and
wherein rotating the end cap with respect to the disc to align the end cap opening with the first disc opening allows air intake according to the dimension of the first disc opening.

4. The device of claim 1, wherein the body is a tubular body comprising a first end, and a second end opposite the first end,
wherein the first end is the mouthpiece,
wherein the constraint structure comprises at least one finger hole on the tubular body, the finger hole sized to be completely covered by a finger of the user, the finger hole allowing intake of air therethough, and the tubular body allowing communication of the intake air to the mouthpiece, and
wherein, aside from the at least one finger hole, the tubular body has no other opening to allow intake of air to be communicated to the mouthpiece.

5. The device of claim 4, wherein the at least one finger hole comprises a first finger hole and a second finger hole, the sizes of the first finger hole and the second finger hole being dissimilar.

6. A compound device comprising:
a strip,
at least two devices structurally joined by the strip, the at least two devices comprising a first device and a second device, wherein each of the first device and the second device is a device according to claim 4.

7. The compound device of claim 6, wherein the at least one finger hole of the first device comprises a first single tubular hole extending from the first end to the second end of the tubular body of the first device, and
wherein the at least one finger hole of the second device comprises a second single tubular hole extending from the first end to the second end of the tubular body of the second device.

8. A method for simulating a progression of a breathing disease, using a breathing capacity simulation device, the method comprising:
adjusting, using a constraint structure configured to constrain, variably, a flow of air therethrough, to a desired constraint level representing a level of progression of the breathing disease; and
breathing, via a mouthpiece having a shape and size suitable for sealable suction of air through the mouth of a user, wherein the breathing capacity simulation device comprises:
the mouthpiece,
the constraint structure, and
a body, sealably coupling the mouthpiece and the constraint structure, wherein breathing air via the mouthpiece causes air intake or out-take only via the constraint structure.

9. The method of claim 8, further comprising
determining, based on the constraint level at which a user is able to sustain breathing orally for a predetermined length of time, an indicator of the disease progression.

10. The method of claim 8, wherein the body is a tubular body comprising a first end, and a second end opposite the first end,
wherein the first end is the mouthpiece,
wherein the constraint structure is proximal to the second end, the constraint structure comprising:
a disc positioned on the second end, in the tubular body in a sealed configuration, forming a barrier to flow of air therethrough, the disc comprising at least one disc opening to allow passage of air therethrough,
an end cap positioned on the second end, the end cap located farther to the first end as compared to the disc, the end cap configured to be in contact with and slide rotatably in relation to the disc when assembled, the end cap comprising an end cap opening larger than the at least one disc opening,
wherein when the at least one disc opening is not eclipsed by the end cap opening, air intake according to the dimension of the at least one disc opening is possible through the constraint structure, and the tubular body enables communication of the intake air to the mouthpiece, and
wherein when the at least one disc opening is completely eclipsed by a portion of the end cap other than the end cap opening, no air intake is possible through the constraint structure.

11. The method of claim 8, wherein the at least one disc opening comprises a first opening and a second disc opening, the sizes of the first opening and the second opening being dissimilar,
wherein the end cap opening is shaped to cover the largest of the at least one disc opening, and
wherein rotating the end cap with respect to the disc to align the end cap opening with the first disc opening allows air intake according to the dimension of the first disc opening.

12. The method of claim 8, wherein the body is a tubular body comprising a first end, and a second end opposite the first end,
wherein the first end is the mouthpiece,
wherein the constraint structure comprises at least one finger hole on the tubular body, the finger hole sized to be completely covered by a finger of the user, the finger hole allowing intake of air therethough, and the tubular body allowing communication of the intake air to the mouthpiece, and
wherein, aside from the at least one finger hole, the tubular body has no other opening to allow intake of air to be communicated to the mouthpiece.

13. The method of claim 8, wherein the at least one finger hole comprises a first finger hole and a second finger hole, the sizes of the first finger hole and the second finger hole being dissimilar.

14. The method of claim 9, further comprising determining, based on the constraint level at which a user is able to sustain inhaling orally for a predetermined length of time, a level of the disease progression.

15. A kit for enabling a user to simulate a progression of a breathing disease, the kit comprising:
a breathing capacity simulation device, including
a mouthpiece having a shape and size suitable for sealable flow of air through the mouth of a user;
a constraint structure configured to constrain, variably, a flow of air therethrough, to a desired constraint level representing a level of progression of the breathing disease;
a body, sealably coupling the mouthpiece and the constraint structure; and
an instructional material for using the breathing capacity simulation device,
wherein suction of air via the mouthpiece causes air intake only via the constraint structure.

16. The kit of 15 where the instruction material comprises at least one of a booklet, an application that operates on a users cellular phone, a computer monitor online program, a website, a flash memory, or a diary.
